(19) United States
(12) Patent Application Publication
(10) Pub. No.: US 2020/0065124 A1
(43) Pub. Date: Feb. 27, 2020

(54) SHORTENING JUST-IN-TIME CODE WARM UP TIME OF DOCKER CONTAINERS

(71) Applicant: International Business Machines Corporation, Armonk, NY (US)

(72) Inventors: QIN YUE CHEN, ZHANGJIANG HIGH TECH PARK (CN); QI LIANG, SHANGHAI (CN); GUI YU JIANG, SHANGHAI (CN); XIN LIU, Shanghai (CN); CHANG XIN MIAO, Shanghai (CN); XING TANG, SHANGHAI (CN); Fei Fei Li, Cixi (CN); Su Han, SHANGHAI (CN)

(21) Appl. No.: 16/108,998

(22) Filed: Aug. 22, 2018

(51) Int. Cl. G06F 9/455; G06F 8/41

(52) U.S. Cl. CPC G06F 9/4552; G06F 8/4441; G06F 2009/45579; G06F 2009/45575; G06F 9/45558

(57) ABSTRACT

According to one or more embodiments of the present invention, a computer-implemented method for shortening just-in-time compilation time includes creating a first container for executing a first computer program, the execution comprising generating, using a just-in-time compiler, a compiled code for a first code-portion of the first computer program. The method further includes storing the compiled code for the first code-portion in a code-share store. The method further includes creating a second container for executing a second computer program comprising a second code-portion. The method further includes determining that the second code-portion matches the first code-portion, and in response retrieving the compiled code from the code-share store for executing the second computer program.

### BACKGROUND

The present invention relates generally to the field of computer code compilation, and more particularly to just-in-time (JIT) compiler performance optimization.

Bytecode is a binary representation of program code that is an intermediate representation between source code and machine code. Bytecode is typically more “portable” than machine code, meaning that bytecode tends to reduce code dependence on a limited set of hardware and/or operating system environments. At the same time, bytecode is also typically more efficient than source code in that it can usually be translated into machine code (also called “native machine language”) during runtime much faster than source code can be translated into machine code. Bytecode may be “compiled” into native machine language for execution, or it may be executed on a virtual machine that “interprets” the bytecode as it runs. Different sections of the bytecode used in a single program can be handled in different ways. For example, some sections may be compiled, while others are interpreted.

Just-in-time (JIT) compilation, also referred to as dynamic translation, is a method for compiling software code from a source format, such as bytecode, to native machine language. JIT compilation is a hybrid approach to code conversion, with compilation occurring during runtime, similar to how interpreters operate during runtime, but in chunks, as with traditional, ahead-of-time compilers. Often, there is caching of compiled code (also called “translated code”) to improve performance.

Java is a well-known class-based, object-oriented computer programming language. In the context of Java, a “method” is a subroutine, or procedure, associated with a class. Java source format code is typically translated to bytecode that can be run on a Java Virtual Machine (JVM) regardless of the underlying hardware or software platform. JVMs often employ JIT compilation to convert Java bytecode into native machine code, which can: (i) improve application runtime performance (for example, speed) relative to interpretation; and (ii) include late-bound data types and adaptive optimization, unlike ahead-of-time compilation.

### SUMMARY

According to one or more embodiments of the present invention, a computer-implemented method for shortening just-in-time compilation time includes creating a first container for executing a first computer program, the execution comprising generating, using a just-in-time compiler, a compiled code for a first code-portion of the first computer program. The method further includes storing the compiled code for the first code-portion in a code-share store. The method further includes creating a second container for executing a second computer program comprising a second code-portion. The method further includes determining that the second code-portion matches the first code-portion, and in response retrieving the compiled code from the code-share store for executing the second computer program.

According to one or more embodiments of the present invention, a system includes a memory device, and a computing machine coupled with the memory device configured to perform a method for shortening just-in-time compilation time. The method for shortening just-in-time compilation time includes creating a first container for executing a first computer program, the execution comprising generating, using a just-in-time compiler, a compiled code for a first code-portion of the first computer program. The method further includes storing the compiled code for the first code-portion in a code-share store. The method further includes creating a second container for executing a second computer program comprising a second code-portion. The method further includes determining that the second code-portion matches the first code-portion, and in response retrieving the compiled code from the code-share store for executing the second computer program.

According to one or more embodiments of the present invention, a computer program product includes a computer readable storage medium having stored thereon program instructions executable by one or more processing devices to shorten just-in-time compilation time. The method for shortening just-in-time compilation time includes creating a first container for executing a first computer program, the execution comprising generating, using a just-in-time compiler, a compiled code for a first code-portion of the first computer program. The method further includes storing the compiled code for the first code-portion in a code-share store. The method further includes creating a second container for executing a second computer program comprising a second code-portion. The method further includes determining that the second code-portion matches the first code-portion, and in response retrieving the compiled code from the code-share store for executing the second computer program.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows a structure of a computer system and computer program code that may be used to implement a method for dynamic container deployment and shorten the JIT code warm up time for the container(s) in accordance with embodiments of the present invention;

FIG. 2 depicts an example dataflow diagram for container deployment and JIT compilation in a computer system;

FIG. 3 depicts an example dataflow diagram for container deployment and shortened JIT compilation in a computer system according to one or more embodiments of the present invention;

FIG. 4 shows an example block diagram of a data structure stored in a code-share store according to one or more embodiments of the present invention;

FIG. 5 depicts an embodiment of the present invention in which multiple containers execute on separate computer systems;

FIG. 6 depicts a flowchart for an example method for accessing and using optimized compiled native code according to one or more embodiments of the present invention; and

FIG. 7 depicts a flowchart of an example method for updating native code with optimized native code according to one or more embodiments of the present invention.

### DETAILED DESCRIPTION

In computer program applications (“applications”), a software container (“container”) can automate and simplify a deployment of a software application in a virtualized operating environment, such as a cloud-computing platform or in a large enterprise network. A container may comprise a standalone computing environment in which is installed one or more configured computer applications, infrastructure, and associated software. Such a container functions as a “black box” software object that, when deployed, presents a virtualized turnkey computing environment that does not require the complex installation procedures required to provision and configure virtual infrastructure on a conventional cloud-computing or virtualized enterprise platform.

In one or more examples, a deployed application comprised of a container may require different sets of component software, configuration settings, or resources, depending on the application's lifecycle phase. Different containers might, for example, be required to deploy the application while the application was in a development, a test, or a production phase. In some cases, an application that is deployed for development purposes may require a container that includes design and development tools. If deployed for test purposes, that same application might instead require debugging software or test datasets. A container used to deploy the application in a production environment may require a set of production-oriented security policies or configuration settings.

Embodiments of the present invention may be used to add functionality to any sort of container-creation or deployment technology, platform, or service or to similar object-oriented deployment tools or applications. In order to more clearly explain the operation and context of the present invention, however, examples described in this document refer to containers and functionality associated with the open-source “Docker” technology, which is, at the time of the filing of this patent application, the best-known mechanism for creating, managing, and deploying software containers. Nonetheless, the use of Docker-based examples herein should not be construed to limit embodiments of the present invention to the Docker platform.

Before proceeding to a detailed description of the present invention, this document will first present a brief overview of container technology (as exemplified by the Docker platform) in order to provide context to readers who may not be familiar with container services. Other container technologies, platforms, services, and development applications may comprise similar or analogous data structures and procedures.

A Docker “container” is a self-contained operating environment that comprises one or more software applications and context, such as configuration settings, supporting software, a file system, and a customized computing environment. The container may be structured as a stack of software layers, each of which occupies one corresponding level of the stack.

A Docker container is created, or “deployed” by running an image file that contains or references each layer of the container. An image file may be used many times to deploy many identical containers, and container technologies are thus most often used to quickly install identical copies of a standard operating environment in a large enterprise or cloud-based computing environment. For this reason, Docker image files are not allowed the ability to conditionally install variations of a container. Every deployed container can be relied upon to be identical.

A Docker image file is created by running a “Dockerfile” image-creation, which comprises a set of computer instructions that define a predefined state of the container. Each instruction in an image creates a “layer” of software in the image file that, when the image file is used to deploy an instance of the container, adds one more resource, level of functionality, or configuration setting to the container.

If, for example, a container is intended to deploy a word-processing application on a particular type of virtualized platform, a corresponding Docker image may contain layers of software that, when deployed: create an instance of the word-processing application on that platform; create a file structure that lets users store documents; automatically launch the word processor; and store an interactive help file that may be viewed from within the application. A first layer of this image might load an operating system, a second layer allocate and mount a file system, a third layer install the application, a fourth layer configure the application, and a fifth layer load and launch the application load and automatically display the help file.

Deployment of such a container would thus automatically create a turnkey operating environment in which the word-processor application is configured and launched with a displayed help file under a virtual operating system configured with a file system tailored for use by a word-processor user. This would have been performed by deploying the contents of each software layer of the image file in sequential order. Again, as known in the art, this deployment is a sequential process designed to quickly install large numbers of containers with low overhead. No conditional-deployment or deployment-time tuning is possible.

Docker allows users to author and run “Dockerfile” image-creation files that each comprise predefined sets of instructions, each of which can add a layer to an image file. A Dockerfile may, for example, build an image that in turn deploys an instance of a predefined container within which a user may work. In other words, Dockerfiles build images that in turn create containers, where a container is a standardized operating environment within which a user may access a preconfigured application.

A standard Dockerfile may thus be used to create a standard image for a particular application or operating environment. Such a standard image-creation file or standard image may be derived from one or more previously created standard or “base” files stored in online or local image libraries. A container that deploys a common application in a standard configuration may therefore be implemented by simply running a standard, publicly available Dockerfile or by deploying a standard, publicly available image file. But experienced Docker users may create a custom Dockerfile that adds layers to a standard image-creation file or image file in order to build a custom image that will deploy a more specialized container.

According to one or more embodiments of the present invention, optimized JIT code (or native code) is shared across different Docker containers through a share service agent. For example, the share service agent can be anything that provides share function like a Docker supervisor or special Docker container. There are a variety of programming languages that rely on JIT. In this document, examples are provided using Java language and JVM (Java Virtual Machine), however, the technical solutions described herein can be easily applied to other computing languages. In the one or more embodiments of the present invention a JVM that generates optimized JIT code and stores it in this agent is called a code producer, and a Docker container or JVM that uses existed optimized JIT code is called a code consumer.

The technical solutions address technical problems rooted in computing technology, particularly in container-based applications. In existing container applications, each JIT compilation code requires a long time to warm up for executing the code that is to be compiled and optimizing the compilation result iteration by iteration. Further, in existing systems, JIT compilation code is just stored in memory but not persistent. If the runtime environment restarts, then the JIT compilation process needs to be executed again. Further, in the case of multiple containers, the JIT compilation process is done more than once although the containers are using same Docker image which means they are using same code. In case there are many containers in the host a newly started container cannot get equivalent performance without warming up.

The technical solutions described herein address such technical challenges with existing computer systems by facilitating sharing of compiled JIT code across containers. According to one or more embodiments of the present invention producers generate and save optimized JIT results to a code share store. For example, the producers save (1) JIT compile result, (2) hash code of original code (e.g. byte code to Java), (3) signature of producers, and (4) architecture information of a host machine that is executing the Java code. Further, consumers get optimized JIT results from the code share store. For example, the consumers search using a hash code of the Java code to identify existing JIT code in the code share store and use the existing JIT code thereby avoiding re-compilation.

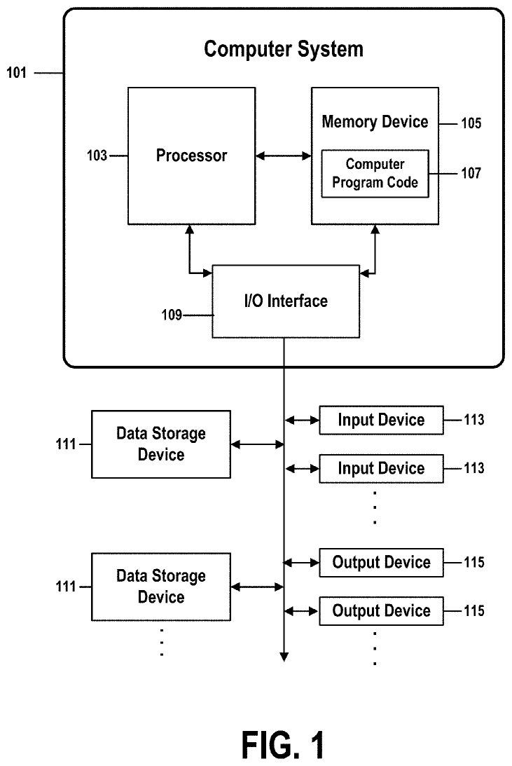

FIG. 1 shows a structure of a computer system and computer program code that may be used to implement a method for dynamic container deployment and shorten the JIT code warm up time for the container(s) in accordance with embodiments of the present invention. As depicted, computer system 101 includes a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may include, but are not limited to: input devices 113, such as keyboards, scanners, handheld telecommunications devices, touch-sensitive displays, tablets, biometric readers, joysticks, trackballs, or computer mice; and output devices 115, which may include, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for shortening JIT warm up time for dynamic containers that are deployed in accordance with embodiments of the present invention. The data storage devices 111 may store the computer program code 107. Computer program code 107 stored in the storage devices 111 is configured to be executed by processor 103 via the memory devices 105. Processor 103 executes the stored computer program code 107.

In some embodiments, rather than being stored and accessed from a hard drive, optical disc or other writeable, rewriteable, or removable hardware data-storage device 111, stored computer program code 107 may be stored on a static, non-removable, read-only storage medium such as a Read-Only Memory (ROM) device 105, or may be accessed by processor 103 directly from such a static, non-removable, read-only medium 105. Similarly, in some embodiments, stored computer program code 107 may be stored as computer-readable firmware 105, or may be accessed by processor 103 directly from such firmware 105, rather than from a more dynamic or removable hardware data-storage device 111, such as a hard drive or optical disc.

Thus the one or more embodiments of the present invention facilitate supporting computer infrastructure, integrating, hosting, maintaining, and deploying computer-readable code into the computer system 101, wherein the code in combination with the computer system 101 is capable of performing a method for dynamic container deployment and shortened JIT warm up time.

Any of the components of the present invention could be created, integrated, hosted, maintained, deployed, managed, serviced, supported, etc. by a service provider who offers to facilitate a method for dynamic container deployment. Thus the present invention discloses a process for deploying or integrating computing infrastructure, comprising integrating computer-readable code into the computer system 101, wherein the code in combination with the computer system 101 is capable of performing a method for dynamic container deployment with shortened JIT warm up time.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may include the computer-readable hardware storage device.

While it is understood that program code 107 for dynamic container deployment with shortened JIT warm up time may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory. It should be noted that other techniques can be used for delivering the program code 107 to the client computer or any other computing device that is to execute the program code 107.

According to one or more embodiments of the present invention optimized JIT code with the shortened warm up time can be shared across different containers created by the same image. It can be also shared between containers created by different images on a single machine or different machines. For simplicity of explanation, in the present document sharing code between containers created by the same image on a single machine is described which can be extended to more complex scenarios by a person skilled in the art.

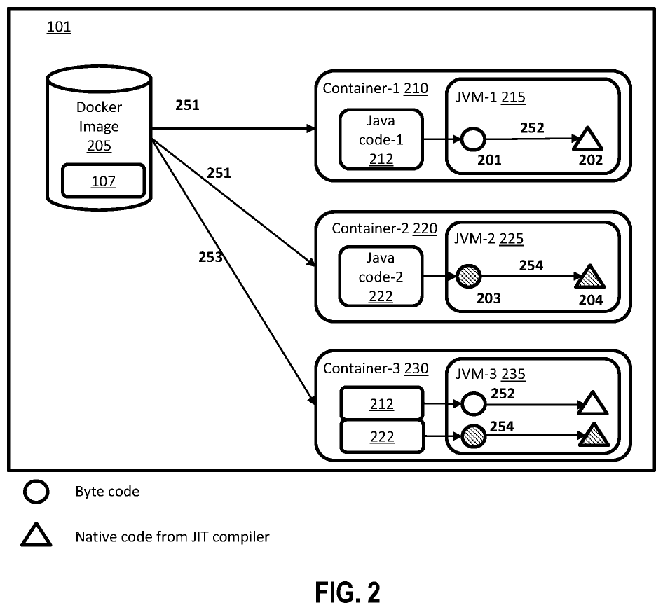

FIG. 2 depicts an example dataflow diagram for container deployment and JIT compilation in a computer system 101. The computer system 101 is executing program code 107 from a Docker image 205. For executing Java code 212 in the Docker image 205, a first container 210 is deployed, as shown at 251. The first container 210 includes a JVM 215. The JVM 215 performs a JIT compilation of the byte code (high-level code) 201 of the Java code 212 to obtain the corresponding native code 202, as shown at 252.

In a similar manner, for executing Java code 222, a second container 220 is deployed. The second container 220 includes another instance of the JVM 225 that performs the JIT compilation of the byte code (high-level code) 203 of the Java code 222 to obtain the corresponding native code 204, at 254. Here, the byte code 203 and the native code 204 are code portions in the Java code 222.

Further, in one or more examples, the computer system 101 can optimize the program code 107 from the Docker image 205, and replace the old program code, at 253. The optimization includes deploying a third container 230 that includes a third JVM instance 235. The JVM 235 performs JIT compilation for the optimized byte code 201, 203 of the Java code 212 and the Java code 222, respectively, to obtain corresponding native code 202, and 204, at 252, 254. In one or more examples, the optimization may be repeated until at least a predetermined level of optimization is obtained.

Here, the first container 210 and the second container 220 are code producers, and the third container 230 is the code consumer as described herein.

As noted earlier, each JIT compilation takes a significant time to warm up, running the hot code and optimizing the compilation result iteration by iteration. As is known, in programming, and particularly, Java programming hot code replace (HCR) is a debugging technique whereby a Java debugger transmits new class files over the debugging channel to another JVM. HCR facilitates a programmer to start a debugging session using a first JVM and change a Java file in the development workbench, and the debugger replaces the code in the receiving JVM while it is running. No restart is required, hence the reference to “hot”.

Also, in existing techniques, JIT compilation code is stored in memory but not made persistent. In one or more examples, for each JVM 215, 225, 235, the JIT compilation code can be persistent in one file, which cannot be shared across containers 210, 220, 230. If the runtime environment restarts, JIT compilation process needs to be executed again for the Java code 212 and 222. Further, In the case of multiple containers 210, 220, 230, the JIT compilation process (252, 254) needs to be done more than once although the containers 210, 220, 230 are using the same Docker image 205 and thus, are using the same Java code 212, 222. Further yet, such execution can lead to a large number of containers to be deployed in the computer system 101 and each newly deployed container cannot get equivalent performance without warming up. The “warm up” includes data caching, instruction caching, and other such preliminary optimization steps that facilitate computer programs to execute faster. Without the warm up phase, i.e. the caching, the execution of the instructions in the container can be slower.

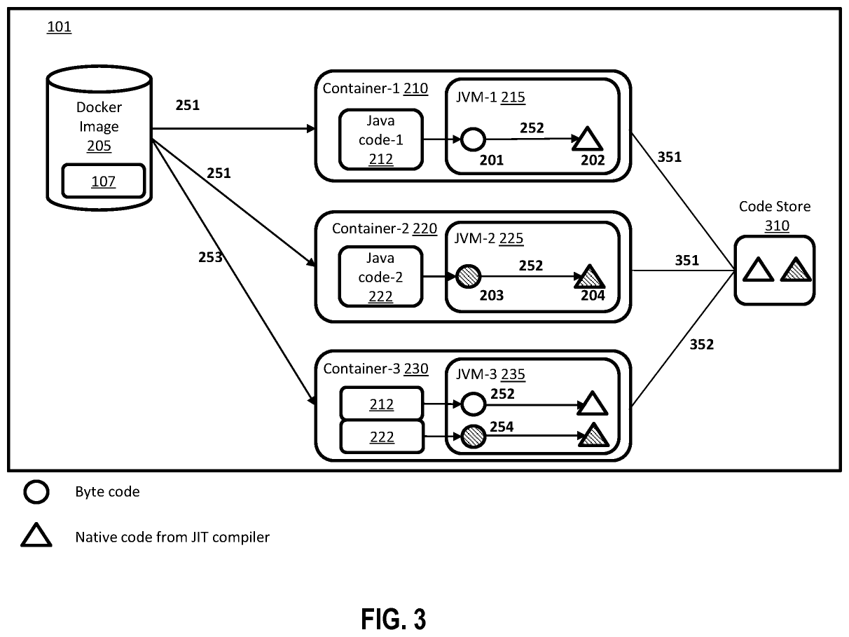

FIG. 3 depicts an example dataflow diagram for container deployment and shortened JIT compilation in the computer system 101 according to one or more embodiments of the present invention. The depicted dataflow addresses the above described technical problems by facilitating the computer system 101 to share the optimized JIT code across different containers created by the same Docker image 205. Further, the optimized and compiled native code 202, 204 can be also shared between containers 210, 220, 230 that can be created by different Docker images (not shown) on the computer system 101 or even from different machines.

To share optimized and compiled native JIT code 202, 204, a code producer, that is the first container 210 and the second container 220, stores at least the following four items in a code-share store 310 for sharing the native code 202, 204 among multiple containers 210, 220, and 230, at 351. The description further is provided for the native code 202, however, it is understood that similar operations can be performed for any other native code, such as the native code 204.

First, the native code 202, which is generated with optimization by a JIT compiler is stored in the code-share store 310. The shared native code 202 can be at any granularity (e.g. class level, function level, loop level, etc.). As an example, in the present document, native code is specified to be shared at function level, i.e. JVM runs Java byte code, and JIT compiler then optimizes hot functions within this Java byte code and save the optimization results to agent.

Further, a host machine architecture information, such as processor family, processor model, and the like are stored in the code-share store 310 in conjunction with the native code 202. Because the native code 202 is generated and optimized for the specific host machine (i.e. computer system 101), the processor architecture, or optimization level, and other such host machine information is stored to ensure that the shared code can be executed under a new runtime environment.

Further, an identifier for the JIT compiler used to perform the JIT compilation of the byte code 201 to obtain the native code 202 that is being stored in the code-share store 310 is also stored. For security consideration, a JVM 215, 225, 235, verifies if shared native code 202 is from a trustable code producer. This prevents the execution of shared code that is modified maliciously.

In cases where the containers 210, 220, and 230, are created by the same image 205 on a single computer system 101, these containers 210, 220, and 230 form a group. The JIT code 202 that is generated by a group member can be used directly by another group member. Therefore, a group identifier is also attached to the shared JIT code 202. In one or more examples, the group identifier can be encrypted and decrypted in either symmetric or asymmetric way. Because the containers 210, 220, and 230 are from a single Docker image 205, the group identifier and keys are easily delivered to each container when it is created and deployed.

Further yet, the code-share store 310 stores a Hash code of original Java byte code 201 upon which the JIT compilation is performed. The hash code of original Java byte code 201 is used as search key, in one or more examples. JVM 215, 225, and 235, can use the hash code to search for optimized native code 202 in the code-share store 310.

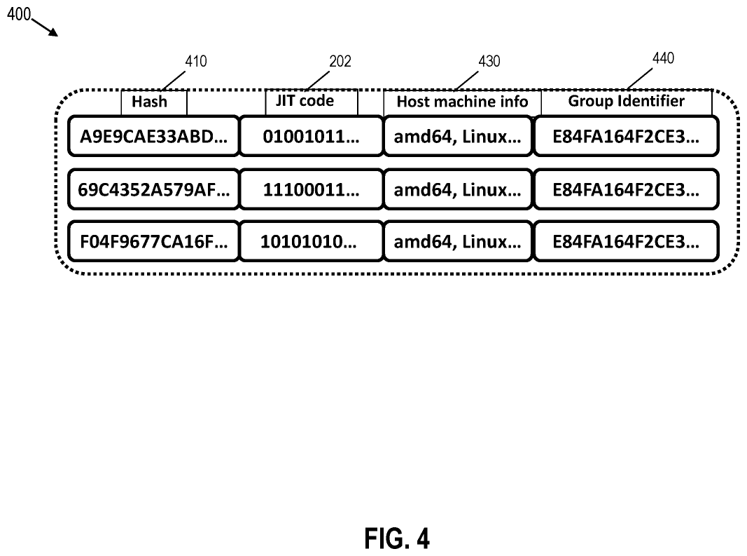

FIG. 4 shows an example block diagram of a data structure stored in the code-share store 310 according to one or more embodiments of the present invention. The data structure 400 includes the hash code 410 of the byte code 201. The data structure 400 further includes the native code 202 corresponding to the byte code 201. The native code is obtained by performing the JIT compilation on the byte code 201. The data structure 400 further includes the computer system information 430, such as the processor make, processor model, processor version, operating system make, operating system version, and the like. The data structure 400 further includes a group identifier 440 that indicates the Docker image 205 of which the byte code 201 is a part. FIG. 4 shows 3 entries in the data structure 400, however, it is understood that data structure can include a different number of entries in other examples.

The third JVM 235 can benefit from one or more of the optimized JIT code 202 stored in the code-share store 310 at least under two situations. First, during JVM interpreter initialization phase, the third JVM 235 can perform a batch pre-load of shared code packages from the code-share store 310. This code package contains optimized JIT code 202, which has high possibility to be used in execution afterwards. Second, during JIT compilation phase the JIT compiler uses the shared native code 202 to skip local re-compilation. For example, referring to FIG. 3, the third JVM 235 can access the native code 204 that is stored by the first JVM 215 and/or the second JVM 225 into the code-share store 310, at 352.

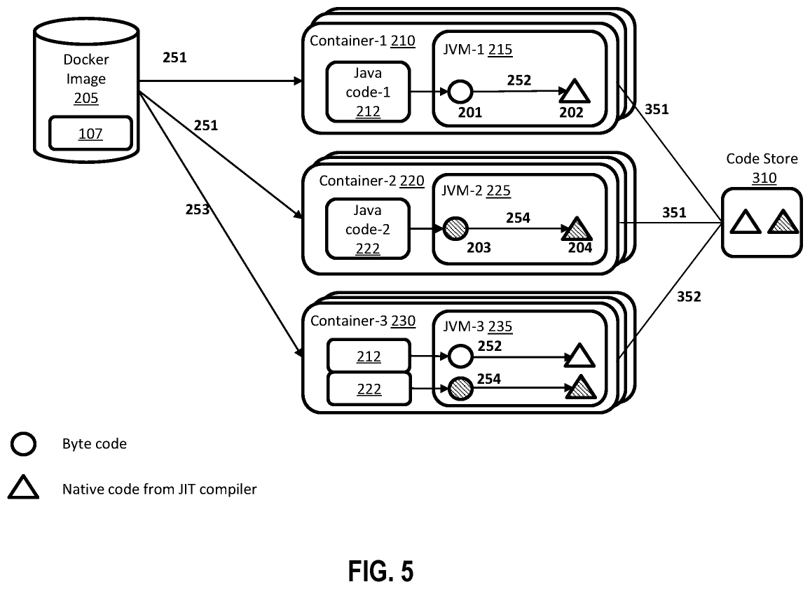

FIG. 5 depicts an embodiment of the present invention in which the containers 210, 220, and 230 execute on multiple computer systems 101. Here, as in the case with a single computer system 101, the containers 210, 220, and 230 are deployed for executing Java code 212, 214 in the Docker image 205. In this case, the containers 210, 220, and 230 may be executed across different computer systems 101, for example, the first container 210 executing on a first computer system 101, the second container 220 executing on a second computer system 101, and the third container 230 executing on a third computer system 101. It is understood that other combinations for executing the containers 210, 220, and 230 across different computer systems 101 is possible in other examples. The operation of the system, which now includes the multiple computer systems 101, is similar to the earlier case, where the JIT compiled native code 202 is stored in the code-share store 310 and accessed by the third JVM 235 during optimization and/or execution of the Java code 212/222.

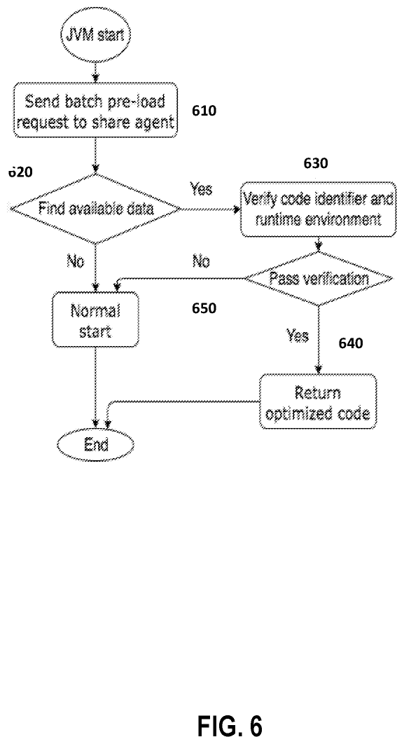

FIG. 6 depicts a flowchart for an example method for accessing and using optimized compiled native code 202 according to one or more embodiments of the present invention. In this case, once the third JVM 235 starts, it sends a preload request to the code-share store 310, at 610. The preload request can include the identifier information for the Java code and/or the byte code 201 that the JVM 235 has to execute. If native code 202 corresponding to the identifier information is identified in the code-share store 310, the other items in the corresponding identifier are verified to ensure that the native code 202 can be used in the present runtime environment, at 620 and 630. For example, the processor architecture, operating system, etc. are compared with the present information. If the verification is successful, that is the information matches, the optimized native code 202 from the code-share store 310 is returned and used for executing the byte code 201, at 640. In case the native code 202 is not available in the code-share store 310, the JVM 235 executes the byte code 201 as typical byte code 201 by initiating a JIT compilation and generating the corresponding native code 202, at 650. In one or more examples, the preload request can be a batch preload request to access more than one byte code portions 201.

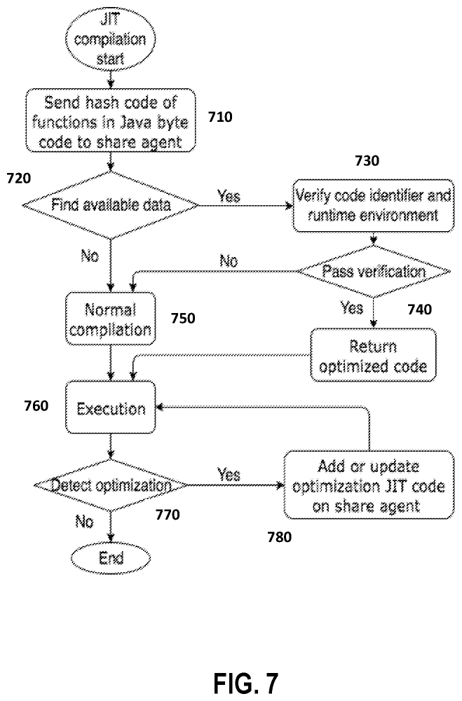

FIG. 7 depicts a flowchart of an example method for updating native code 202 with optimized native code according to one or more embodiments of the present invention. In this case, once the third JVM 235 encounters byte code 201 that may need JIT compilation, the JVM 235 sends hash codes of functions in the byte code 201 to the code-share store 310, at 710. If the code-share store 310 includes native code 202 corresponding to the hash code, the other items in the corresponding identifier are verified to ensure that the native code 202 can be used in the present runtime environment, at 720 and 730. For example, the processor architecture, operating system, etc. are compared with the present information. If the verification is successful, that is the information matches, the native code 202 from the code-share store 310 is returned and used for executing the byte code 201, at 740. In case the native code 202 is not available in the code-share store 310, or if the verification is not successful, JIT compilation of the byte code 201 is performed to obtain the corresponding native code 202, at 750.

The native code 202 obtained, either by JIT compilation or from the code-share store 310, is executed, at 760. During the execution, if an optimization for the native code 202/byte code 201 is detected, the optimization is performed and the optimized native code is stored in the code-share store 310 in place of the native code 202, at 770 and 780. The optimized native code is then executed at 760 and the optimization check is performed again, at 770. If no optimization is to be performed, the native code 202 execution continues to completion, at 770.

The one or more embodiments of the present invention accordingly facilitate shortening the compilation time of the code in containers. Different containers are created based on the same code image. Virtual machines in each container runs the first code and second code respectively. The virtual machines can use a JIT compiler to optimize native code for the first code and the second code and the JIT code is stored in a code-share store, ready for other containers to reference. At a later time if a third virtual machine in another container starts to run the first code and the second code, the optimized native code that has already be generated and stored in the code-share store can be reused by the third virtual machine. After verifying the code compatibility and credibility, the third virtual machine uses the JIT code made by the first virtual machine and the second virtual machine.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for shortening just-in-time compilation time, the method comprising:
creating a first container for executing a first computer program, the execution comprising generating, using a just-in-time compiler, a compiled code for a first code-portion of the first computer program;
storing the compiled code for the first code-portion in a code-share store;
creating a second container for executing a second computer program comprising a second code-portion; and
determining that the second code-portion matches the first code-portion, and in response retrieving the compiled code from the code-share store for executing the second computer program, wherein the first computer program is being executed on a first machine and the second computer program is being executed by a second machine and the second code-portion is determined to match the first code-portion based on a first hash code of the first code-portion and a second hash code of the second code-portion, further comprising:
optimizing the compiled code during execution of the second computer program; and
replacing the compiled code in the code-share store with an optimized compiled code.

2. (canceled)

3. (canceled)

4. The computer-implemented method of claim 1, wherein storing the compiled code from the just-in-time compiler comprises storing a first hash code of the first code-portion as part of a signature of the compiled code.

5. The computer-implemented method of claim 4, wherein the signature of the compiled code further comprises storing machine information of a first machine executing the first code-portion.

6. The computer-implemented method of claim 5, wherein the machine information comprises processor architecture information, and operating system version.

7. (canceled)

8. A system, comprising:
a memory device; and
a computing machine coupled with the memory device configured to perform a method for shortening just-in-time compilation time, the method comprising:
creating a first container for executing a first computer program, the execution comprising generating, using a just-in-time compiler, a compiled code for a first code-portion of the first computer program;
storing the compiled code for the first code-portion in a code-share store;
creating a second container for executing a second computer program comprising a second code-portion; and
determining that the second code-portion matches the first code-portion, and in response retrieving the compiled code from the code-share store for executing the second computer program, wherein the first computer program is being executed on a first machine and the second computer program is being executed by a second machine and the second code-portion is determined to match the first code-portion based on a first hash code of the first code-portion and a second hash code of the second code-portion, further comprises:
optimizing the compiled code during execution of the second computer program; and
replacing the compiled code in the code-share store with an optimized compiled code.

9. (canceled)

10. (canceled)

11. The system of claim 8, wherein storing the compiled code from the just-in-time compiler comprises storing a first hash code of the first code-portion as part of a signature of the compiled code.

12. The system of claim 11, wherein the signature of the compiled code further comprises storing machine information of a first machine executing the first code-portion.

13. The system of claim 12, wherein the machine information comprises processor architecture information, and operating system version.

14. (canceled)

15. A computer program product comprising a computer readable storage medium having stored thereon program instructions executable by one or more processing devices to shorten just-in-time compilation time, which comprises:
creating a first container for executing a first computer program, the execution comprising generating, using a just-in-time compiler, a compiled code for a first code-portion of the first computer program;
storing the compiled code for the first code-portion in a code-share store;
creating a second container for executing a second computer program comprising a second code-portion; and
determining that the second code-portion matches the first code-portion, and in response retrieving the compiled code from the code-share store for executing the second computer program, wherein the first computer program is being executed on a first machine and the second computer program is being executed by a second machine and the second code-portion is determined to match the first code-portion based on a first hash code of the first code-portion and a second hash code of the second code-portion, and wherein shortening further comprises:
optimizing the compiled code during execution of the second computer program; and
replacing the compiled code in the code-share store with an optimized compiled code.

16. (canceled)

17. (canceled)

18. The computer program product of claim 15, wherein storing the compiled code from the just-in-time compiler comprises storing a first hash code of the first code-portion as part of a signature of the compiled code.

19. The computer program product of claim 18, wherein the signature of the compiled code further comprises storing machine information of a first machine executing the first code-portion.

20. (canceled)
